(19) United States
(12) Patent Application Publication
(10) Pub. No.: US 2002/0121500 A1
(43) Pub. Date: Sep. 5, 2002

(54) Method of etching with NH3 and fluorine chemistries

(76) Inventors: Rao Annapragada, Union City, CA (US); Reza Sadjadi, Saratoga, CA (US)

Correspondence Address: BEYER WEAVER & THOMAS LLP, P.O. BOX 778, BERKELEY, CA, 94704-0778, US

(21) Appl. No.: 09/746,900

(22) Filed: Dec. 22, 2000

(51) Int. Cl. B44C 1/22; C03C 15/00

(52) U.S. Cl. 216/67

(57) ABSTRACT

A method of etching a stack using a fluorine containing gas and an ammonia containing gas is provided. Generally, the stack is placed in a plasma processing chamber. A fluorine containing gas is flowed into the plasma processing chamber. An ammonia containing gas is flowed into the plasma processing chamber. A plasma is generated. The stack is then etched.

In addition, a device for etching stacks on a substrate is provided. The device comprises: a plasma chamber with chamber walls; a plasma confinement device for reducing plasma contact with the chamber walls; a gas source; plasma generation and energizing device; and an exhaust system for pumping plasma away. The gas source comprises a fluorine containing gas source and an ammonia containing gas source.

### BACKGROUND OF THE INVENTION

The present invention relates to the fabrication of semiconductor-based devices. More particularly, the present invention relates to improved techniques for fabricating semiconductor-based devices with low dielectric constant materials.

In semiconductor-based device (e.g., integrated circuits or flat panel displays) manufacturing, dual damascene structures may be used in conjunction with copper conductor material to reduce the RC delays associated with signal propagation in aluminum based materials used in previous generation technologies. In dual damascene, instead of etching the conductor material, vias, and trenches may be etched into the dielectric material and filled with copper. The excess copper may be removed by chemical mechanical polishing (CMP) leaving copper lines connected by vias for signal transmission. To reduce the RC delays even further, low dielectric constant materials may be used. Low dielectric constant materials are here defined as materials with a dielectric constant of less than about 3.7. These low dielectric constant materials may include organo-silicate-glass (OSG) materials, such as Coral™ and Black Diamond™, or may be purely organic materials, such as SILK™ or Flare™. OSG materials may be silicon dioxide doped with organic components such as methyl groups. Etching these materials and stripping the photoresist on these materials may be significantly different and much more challenging than when conventional oxide materials are used. Oxygen containing plasmas may not be suitable for stripping resist on OSG materials, since oxygen plasmas may oxidize the organic content of low k OSG materials or may cause bowing during the etch of purely organic low k materials.

To facilitate discussion, FIG. 1A is a cross-sectional view of a stack 100 on a wafer 110 used in the damascene process of the prior art. A contact 104 may be placed in a dielectric layer 108 over the wafer 110. A barrier layer 112, which may be of silicon nitride or silicon carbide, may be placed over the contact 104 to prevent the copper diffusion. A via level low k material layer 116 may be placed over the barrier layer 112 and dielectric layer 108. A trench stop layer 120 may be placed over the via level low k layer 116. A trench level low k material layer 124 may be placed over the trench stop layer 120. A hard mask and/or an antireflective coating (ARC) layer 128 may be placed over the trench level low k material layer 124. A patterned resist layer 132 may be placed over the hard mask and/or an antireflective coating (ARC) layer 128. The via level low k material layer 116 and the trench level low k material layer 124 may be formed from a low dielectric constant OSG material or organic material. The trench etch stop layer 120 may be formed from silicon carbide or silicon nitride. SiON or organic anti reflective coating (BARC) may be used to form the ARC layer 128.

FIG. 1B is a cross-sectional view of the stack 100 after a via 136 and a trench 140 have been etched. To etch through the hard mask and/or an antireflective coating (ARC) layer 128, the etch stop layer 120 and the barrier layer 112 it may be desirable to use a fluorine containing gas as a gas source for an etching plasma. To etch through the via level organic low k material layer 116 and the trench level organic low k material layer 124, it may be desirable to use an ammonia (NH₃) containing gas as a gas source for an etching plasma. In addition, for organic low k materials, a fluorine source may be added to NH₃ to remove any unwanted polymeric residue from the open areas of the wafer. To etch through the via level OSG low k material layer 116 and the trench level OSG low k material layer 124, it may be desirable to use a fluorine containing gas similar to the gas used to etch the ARC layer 128, the etch stop layer 120 and barrier layer 112. To strip the photo resist after via, trench, or barrier etch, it may be desirable to use NH3 gas. After the trench and via etches of OSG materials a polymer crust 144 may be deposited over the patterned resist layer 132 and side walls of the trench 140 and via 140. To remove a silicon containing polymer crust 144 it may be desirable to use a fluorine containing etchant gas in combination with NH3. Although it is desirable to use an etchant gas with a fluorine containing gas and an ammonia containing gas either together or in alternating steps, such attempts in the prior art resulted in the formation of particles, which may contaminate the plasma processing chamber and may increase defects in the resulting semiconductor structure. Thus such processes, which used ammonia and fluorine in the same chamber were avoided.

It is desirable to provide an efficient etching with minimal particle contamination.

### SUMMARY OF THE INVENTION

To achieve the foregoing and other objectives and in accordance with the purpose of the present invention for etching a stack, generally, the stack is placed in a plasma processing chamber. A fluorine containing gas is flowed into the plasma processing chamber. An ammonia containing gas is flowed into the plasma processing chamber. A plasma is generated. The stack is then etched.

In addition, the present invention provides a device for etching stacks on a substrate. The device comprises: a plasma chamber with chamber walls; a plasma confinement device for reducing plasma contact with the chamber walls; a gas source; plasma generation and energizing device; and an exhaust system for pumping plasma away. The gas source comprises a fluorine containing gas source and an ammonia containing gas source.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A-B are cross-sectional views of a stack on a wafer used in the damascene process of the prior art.

FIG. 2 is a schematic view of a plasma processing chamber that may be used in a preferred embodiment of the invention.

FIG. 3 is a flow chart of a process that uses the plasma processing chamber.

FIGS. 4A-B are cross-sectional views of a stack on a wafer used in the damascene process in a preferred embodiment of the invention.

FIG. 5 is a more detailed flow chart for the step of etching the via.

FIGS. 6A-C are cross-sectional views of a stack on a wafer used in the damascene process in a preferred embodiment of the invention after a via has been etched.

FIG. 7 is a more detailed flow chart for the step of etching the trench.

FIG. 8 is a graph of the number of particles over 0.16 microns versus the number of wafers processed found during a test.

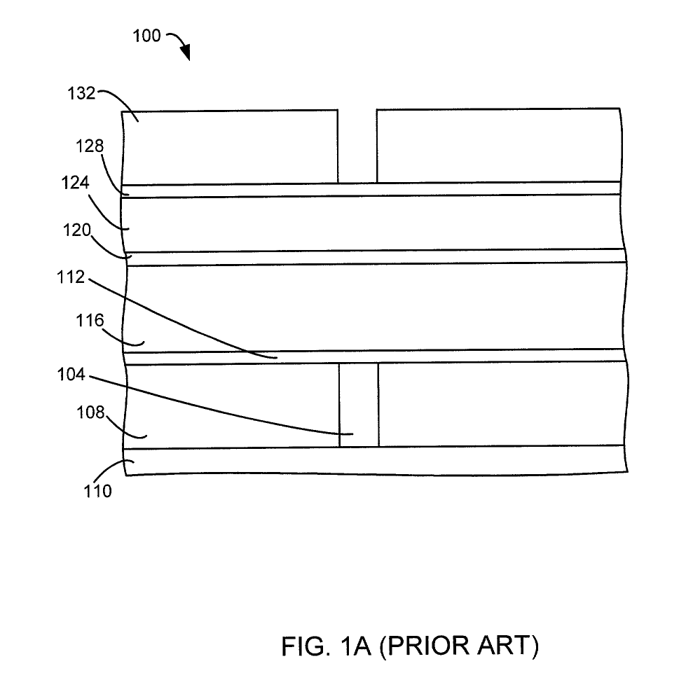

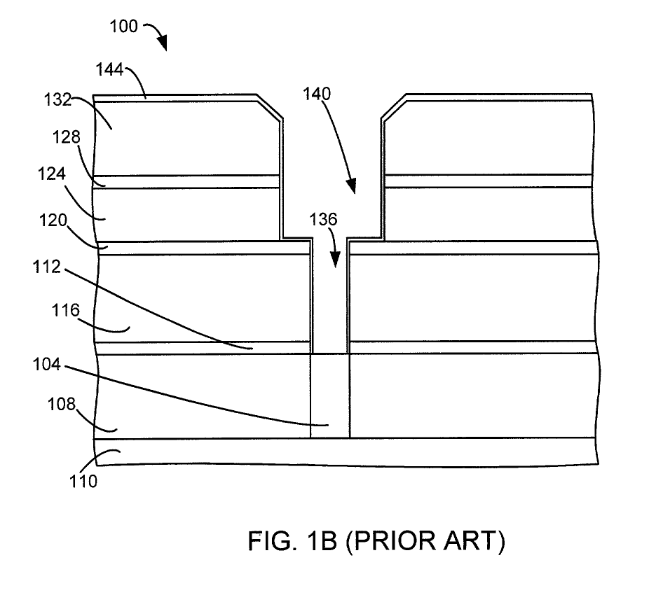

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

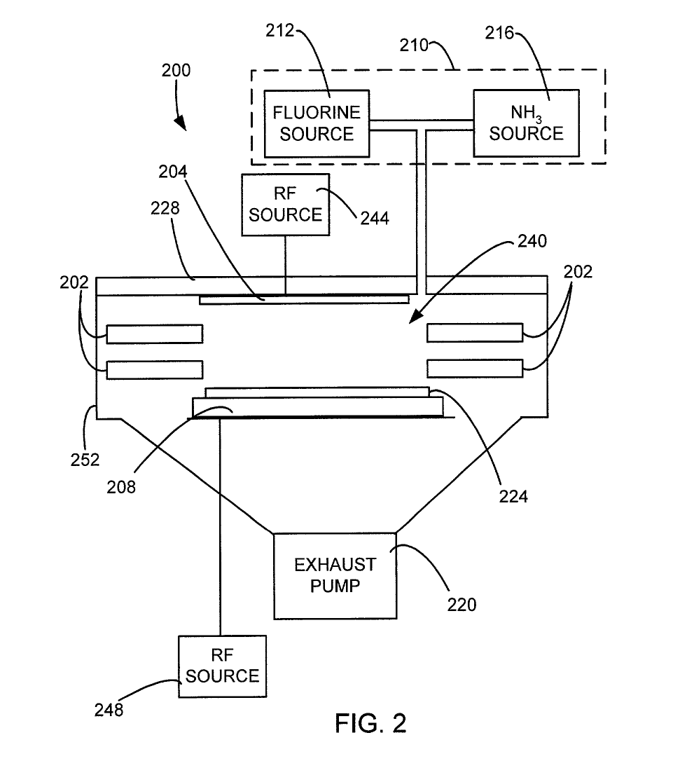

To facilitate discussion, FIG. 2 is a schematic view of a plasma processing chamber 200 that may be used in a preferred embodiment of the invention. The plasma processing chamber 200 comprising confinement rings 202, an upper electrode 204, a lower electrode 208, a gas source 210, and an exhaust pump 220. The gas source 210 comprises a fluorine containing gas source 212 and an ammonia containing gas source 216. The gas source 210 may comprise additional gas sources. Within plasma processing chamber 200, a substrate 224 is positioned upon the lower electrode 208. The lower electrode 208 incorporates a suitable substrate chucking mechanism (e.g., electrostatic, mechanical clamping, or the like) for holding the substrate 224. The reactor top 228 incorporates the upper electrode 204 disposed immediately opposite the lower electrode 208. The upper electrode 204, lower electrode 208, and confinement rings 202 define the confined plasma volume 240. Gas is supplied to the confined plasma volume 240 by gas source 210 and is exhausted from the confined plasma volume 240 through the confinement rings 202 and an exhaust port by the exhaust pump 220. A first RF source 244 is electrically connected to the upper electrode 204. A second RF source 248 is electrically connected to the lower electrode 208. Different combinations of connecting RF power to the electrode are possible. In case of Exelan HP both the RF sources are connected to the lower electrode and the upper electrode is grounded. Chamber walls 252 surround the confinement rings 202, the upper electrode 204, and the lower electrode 208. Both the first RF source 244 and the second RF source 248 may comprise a 27 MHz power source and a 2 MHz power source. The upper electrode 204 and the lower electrode are spaced are preferably spaced apart by a distance of about 1.35 cm but may have a spacing up to 2.0 cm.

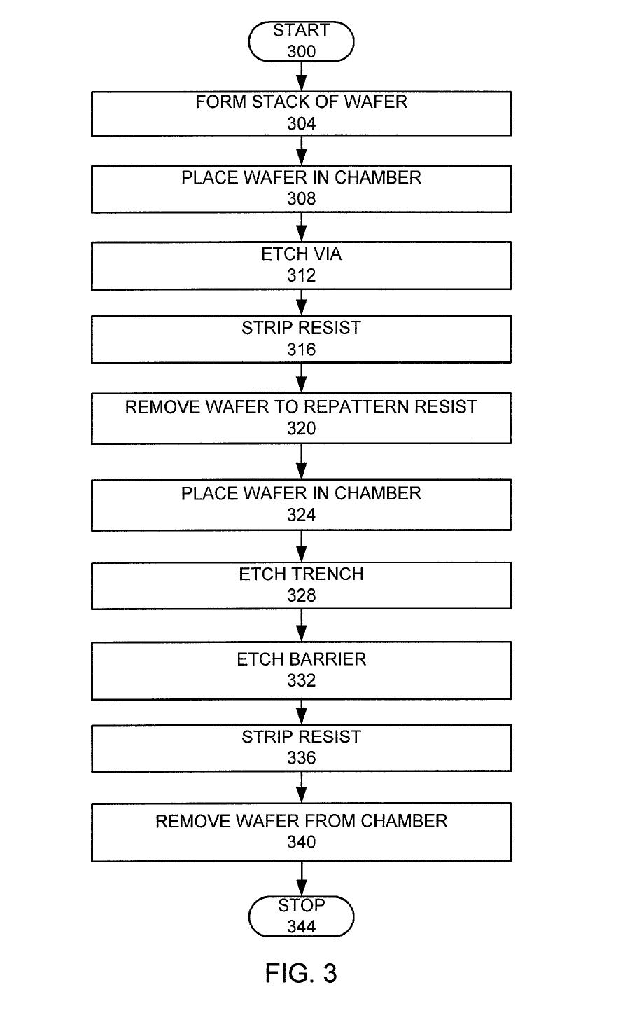

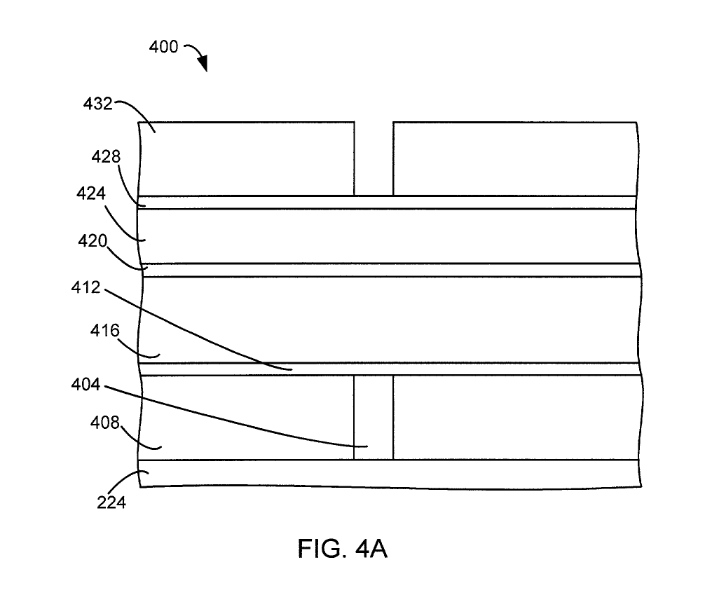

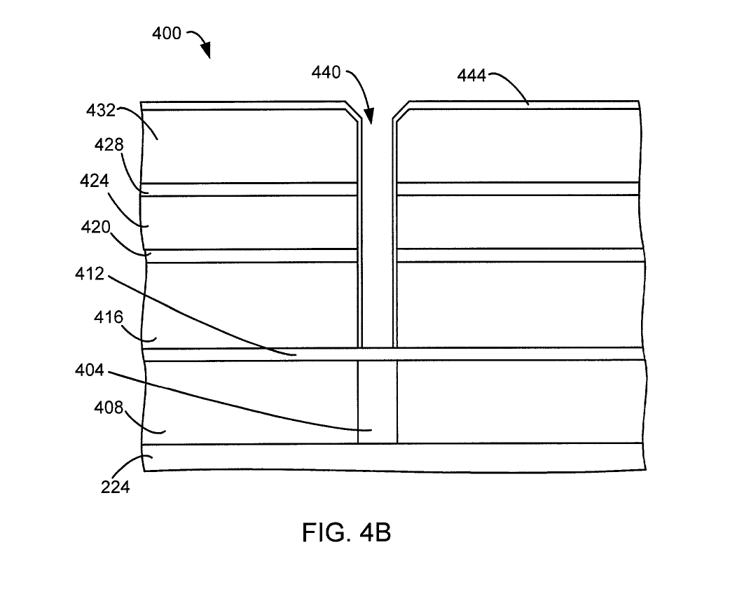

FIG. 3 is a flow chart of a process that uses the plasma processing chamber 200. A stack 400 is formed on a wafer 224 (step 304), as shown in FIG. 4A. A contact 404 may be placed in a dielectric layer 408 over a wafer 224. A barrier layer 412, which may be of silicon nitride or silicon carbide, may be placed over the contact 404 to prevent a copper or metal diffusion. A via level low k material layer 416 may be placed over the barrier layer 412. A trench stop layer 420 may be placed over the via level low k layer 416. In a preferred embodiment, the trench stop layer 420 may be made of silicon nitride (SiN). A trench level low k material layer 424 may be placed over the trench stop layer 420. A hard mask and/or an antireflective coating (ARC) layer 428 may be placed over the trench level low k material layer 424. A patterned resist layer 432 patterned for etching a via may be placed over the hard mask and/or an antireflective coating (ARC) layer 428. The via level low k material layer 416 and the trench level low k material layer 424 may be formed from a low dielectric constant OSG material or organic material. The trench etch stop layer 420 may be formed from silicon carbide, instead of silicon nitride, and the hard mask layer may be formed from SiN. The ARC layer 428 may be formed from SiON or organic anti reflective coating. The patterned resist layer 432 may be made of a photo resist layer with the ARC layer 428 acting as an antireflective coating. The stack 400 may be placed over other layers over the wafer 224.

The wafer 224 may then be placed in the plasma processing chamber 200 (step 308). A via is then etched (step 312). Generally, to provide etching in the plasma processing chamber 200 a gas is flowed from the gas source 210. Energy is provided by the first RF source 244 and the second RF source 248, which energizes and ionizes the gas generating a plasma. The plasma is partially confined to the confined plasma volume 240, where the plasma is able to etch the stack 400 on the wafer 224. The plasma is then vented past the confinement rings 202 to the exhaust pump 220. The confinement rings 202 reduce plasma interaction with the chamber walls 252. FIG. 4B is a schematic view of the stack 400 with an etched via 440. To etch the via 440 the hard mask and or ARC layer 428, the trench level low k material layer 424, the trench stop layer 420, and the via level low k material layer 416 are etched.

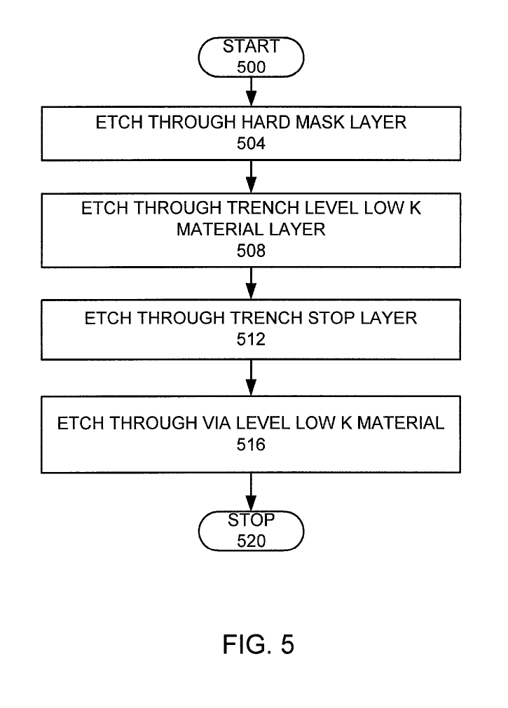

FIG. 5 is a more detailed flow chart for the step of etching the via (step 312) where the trench level low k material 424 and the via level low k material 416 are organic. First the via is etched through the hard mask/ARC layer 428 (step 504). One recipe set of parameters for etching the hard mask/ARC layer 428 is provided in Table I where sccm stands for Standard Cubic Centimeters per minute.

TABLE I

| | | | MORE |
|---|---|---|---|
| | | PREFERRED | PREFERRED |
| PARAMETERS | BROAD RANGE | RANGE | RANGE |
| PRESSURE | 0-140 | 35-105 | 60-80 |
| (mTorr) | | | |
| Flow rate of Ar | 80-320 | 120-200 | 150-170 |
| (sccm) | | | |
| Flow rate of C₄F₈ | 1-9 | 3-7 | 5 |
| (sccm) | | | |
| Flow rate of CF₄ | 10-80 | 30-50 | 35-45 |
| (sccm) | | | |
| Flowrate of O₂ | 4-26 | 10-20 | 13-17 |
| (sccm) | | | |
| Power at 27 MHz | 250-750 | 300-700 | 450-550 |
| (Watts) | | | |
| Power at 2 MHz | 500-1500 | 750-1250 | 900-1100 |
| (Watts) | | | |

In a preferred embodiment for etching the hard mask/ARC layer 428: the flow rate of pressure was approximately 70 mTorr; approximately 500 Watts was provided at 27 MHz; approximately 1,000 Watts was provided at 2 MHz; the flow rate of Argon (Ar) was approximately 160 sccm; the flow rate of oxygen (O₂) was approximately 15 sccm; the flow rate of CF₄ was approximately 40 sccm; the flow rate of C₄F₈ was approximately 5 sccm.

Next the via level organic low k material layer 424 is etched (step 508). One recipe set of parameters for etching the trench level low k material layer 424 is provided in Table II.

TABLE II

| | | | MORE |
|---|---|---|---|
| | | PREFERRED | PREFERRED |
| PARAMETERS | BROAD RANGE | RANGE | RANGE |
| PRESSURE | 0-300 | 100-200 | 140-160 |
| (mTorr) | | | |
| Flow rate of NH₃ | 500-1500 | 750-1250 | 900-1100 |
| (sccm) | | | |
| Power at 27 MHz | 250-750 | 300-700 | 450-550 |
| (Watts) | | | |
| Power at 2 MHz | 0-500 | 0-250 | 0 |
| (Watts) | | | |

In the preferred embodiment for etching the trench level low k material layer 424: the flow rate of pressure was approximately 150 mTorr; approximately 500 Watts was provided at 27 MHz; approximately 0 Watts was provided at 2 MHz; the flow rate of NH₃ was approximately 1,000 sccm. During the via etch of the organic low k material using NH₃ plasma, all the resist material to form the via pattern is removed. After via etch the stack is repatterned with photo resist trench pattern to form trench pattern on the wafers.

Next the trench stop layer 420 is etched (step 512). One recipe set of parameters for etching an SiN trench stop layer 420 is provided in Table III.

TABLE III

| | | | MORE |
|---|---|---|---|
| | | PREFERRED | PREFERRED |
| PARAMETERS | BROAD RANGE | RANGE | RANGE |
| PRESSURE | 0-180 | 60-120 | 80-100 |
| (mTorr) | | | |
| Flow rate of Ar | 75-300 | 100-200 | 130-170 |
| (sccm) | | | |
| Flow rate of CHF₃ | 6-18 | 9-15 | 11-13 |
| (sccm) | | | |
| Flow rate of CF₄ | 10-40 | 15-35 | 20-30 |
| (sccm) | | | |
| Flow rate of O₂ | 5-15 | 7-13 | 9-11 |
| (sccm) | | | |
| Flow rate of N₂ | 15-45 | 20-40 | 25-35 |
| (sccm) | | | |
| Power at 27 MHz | 300-1200 | 450-750 | 550-650 |
| (Watts) | | | |
| Power at 2 MHz | 50-200 | 75-125 | 90-110 |
| (Watts) | | | |

In the preferred embodiment for etching the trench stop layer 420: the flow rate of pressure was approximately 90 mTorr; approximately 600 Watts was provided at 27 MHz; approximately 100 Watts was provided at 2 MHz; the flow rate of Argon (Ar) was approximately 150 sccm; the flow rate of oxygen (O₂) was approximately 10 sccm; the flow rate of CF₄ was approximately 25 sccm; the flow rate of CHF₃ was approximately 12 sccm; the flow rate of N₂ was approximately 30 sccm.

Next the trench level low k material layer 424 is etched (step 516). One recipe set of parameters for etching the trench level low k material layer 424 is provided in Table IV.

TABLE IV

| | | | MORE |
|---|---|---|---|
| | | PREFERRED | PREFERRED |
| PARAMETERS | BROAD RANGE | RANGE | RANGE |
| PRESSURE | 0-300 | 100-200 | 140-160 |
| (mTorr) | | | |
| Flow rate of NH₃ | 500-1500 | 750-1250 | 900-1100 |
| (sccm) | | | |
| Power at 27 MHz | 250-750 | 300-700 | 450-550 |
| (Watts) | | | |
| Power at 2 MHz | 0-500 | 0-250 | 0 |
| (Watts) | | | |

In the preferred embodiment for etching the via level low k material layer 416: the flow rate of pressure was approximately 150 mTorr; approximately 500 Watts was provided at 27 MHz; approximately 0 Watts was provided at 2 MHz; the flow rate of NH₃ was approximately 1,000 sccm;.

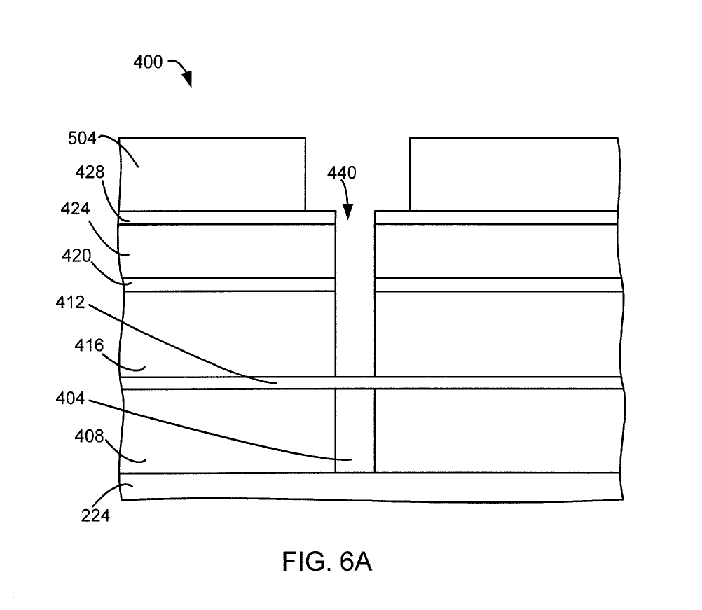

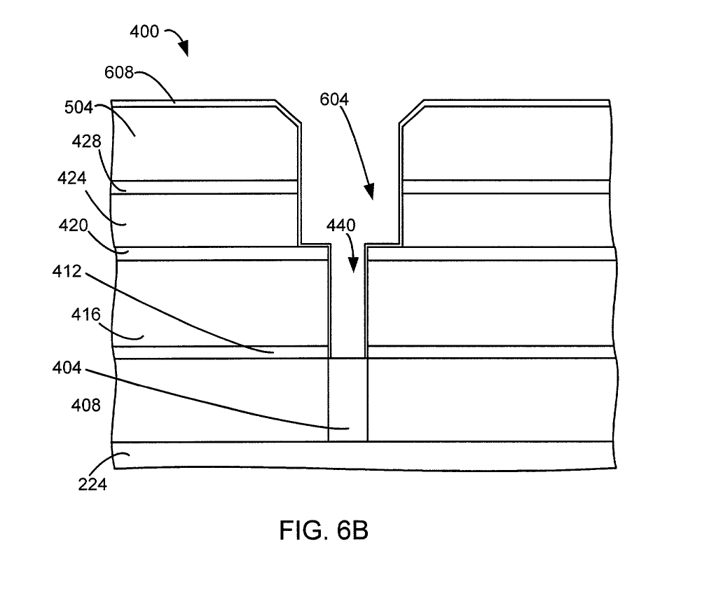

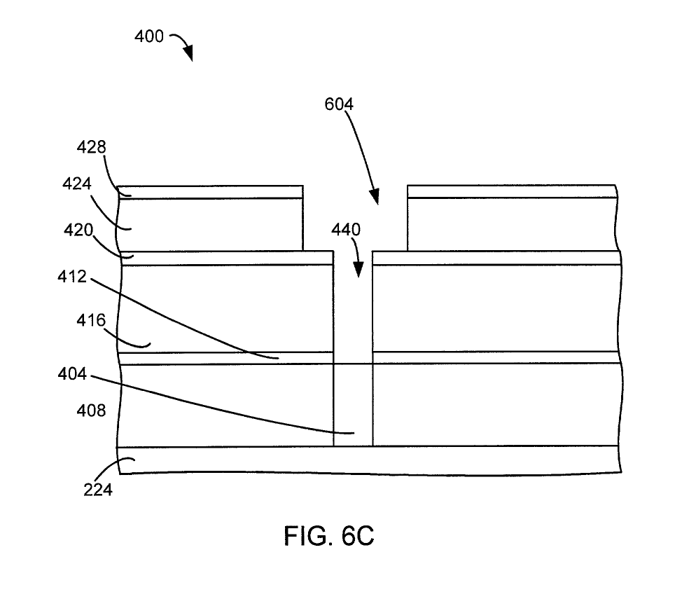

While etching via 440 in the OSG low k materials to the barrier layer 412 the via etching may be stopped. A silicon containing polymer crust 444 may be deposited over the patterned resist layer 432 and the sidewalls of the via 440 as a result of the via etching. The plasma chamber 200 may be used to strip the polymer crust 444, when etching OSG low k materials, and the patterned resist layer 432, when etching either OSG low k materials or organic low k materials, (step 316). A recipe for stripping the polymer crust 444 and patterned resist layer 432 may use NH₃ as a plasma source gas for stripping the photoresist. Once the polymer crust 444 and patterned resist layer 432 have been stripped, the wafer 224 may be removed from the plasma chamber 200 to allow the depositing of a new patterned resist layer 504 (step 320), as shown in FIG. 6A.

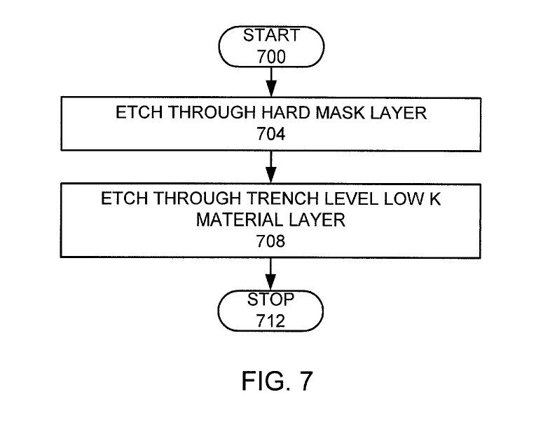

The wafer 224 may be placed back in the plasma chamber 200 (step 324). A trench 604 is etched (step 328), as shown in FIG. 6B. FIG. 7 is a more detailed flow chart for the step of etching the trench (step 328) when the trench level layer 424 is an organic low k material. First, the trench is etched through the hard mask/ARC layer 428 (step 704). One recipe set of parameters for etching the hard mask/ARC layer 428 is provided in Table I above. In a preferred embodiment for etching the hard mask/ARC layer 428: the flow rate of pressure was approximately 70 mTorr; approximately 500 Watts was provided at 27 MHz; approximately 1,000 Watts was provided at 2 MHz; the flow rate of Argon (Ar) was approximately 160 sccm; the flow rate of oxygen (O₂) was approximately 15 sccm; the flow rate of CF₄ was approximately 40 sccm; the flow rate of C₄F₈ was approximately 5 sccm.

Next the trench level organic low k material layer 424 is etched (step 708). One recipe set of parameters for etching the trench level organic low k material layer 424 is provided in Table II. In the preferred embodiment for etching the trench level low k material layer 424: the flow rate of pressure was approximately 150 mTorr; approximately 500 Watts was provided at 27 MHz; approximately 0 Watts was provided at 2 MHz; the flow rate of NH₃ was approximately 1,000 sccm.

Once the trench 604 has been etched to the trench stop layer 420 the trench etching may be stopped. The barrier layer 412 may then be etched (step 332). One recipe set of parameters for etching the barrier layer 412 is provided in Table V.

TABLE V

| | | | MORE |
|---|---|---|---|
| | | PREFERRED | PREFERRED |
| PARAMETERS | BROAD RANGE | RANGE | RANGE |
| PRESSURE | 100-220 | 130-190 | 150-170 |
| (mTorr) | | | |
| Flow rate of Ar | 100-500 | 200-400 | 250-350 |
| (sccm) | | | |
| Flow rate of CHF₃ | 5-40 | 10-30 | 15-25 |
| (sccm) | | | |
| Flow rate of N₂ | 40-200 | 60-140 | 80-120 |
| (sccm) | | | |
| Power at 27 MHz | 300-800 | 500-600 | 400 |
| (Watts) | | | |
| Power at 2 MHz | 50-400 | 100-300 | 200 |
| (Watts) | | | |

In the preferred embodiment for etching the barrier layer 412: the flow rate of pressure was approximately 158 mTorr; approximately 400 Watts was provided at 27 MHz; approximately 200 Watts was provided at 2 MHz; the flow rate of Argon (Ar) was approximately 300 sccm; the flow rate of CHF₃ was approximately 20 sccm; the flow rate of N₂ was approximately 100 sccm.

A silicon containing polymer crust 608 may be deposited over the patterned resist layer 432 and the sidewalls of the via 440 and trench 604 as a result of the trench etching, as shown in FIG. 6B. The plasma chamber 200 may be used to strip the polymer crust 608 and patterned resist layer 504 (step 336). A recipe for stripping the polymer crust 608 and patterned resist layer 504 may use NH₃ as a plasma source gas for stripping the photoresist.

Once the polymer crust 608 and patterned resist layer 504 have been stripped, the wafer 224, as shown in FIG. 6C, may be removed from the plasma chamber 200 (step 340).

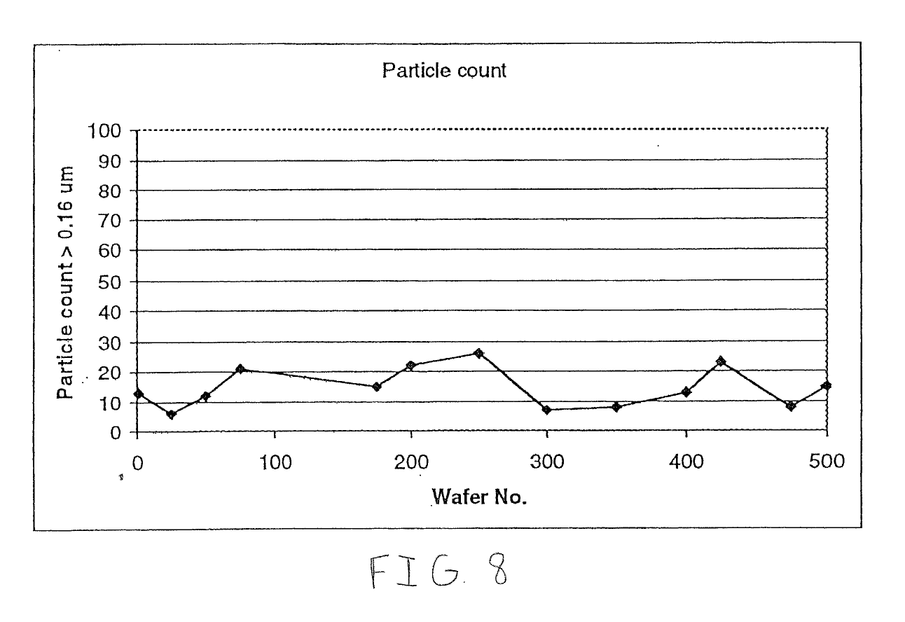

In an Exelan HP, made by LAM Research Corporation™ of Fremont, Calif., a test was performed using the above recipes for 500 wafers. An O₂ clean was done every 60 seconds. Particles were collected periodically in 25 or 50 wafer intervals. A particle count was taken using an NH₃ recipe as described above for 10 seconds, where the particle size monitored was 0.16 to 9,000 microns with 6 mm edge exclusion. The test temperature was about 0° C. FIG. 8 is a graph of the number of particles over 0.16 microns (Particle count) versus the number of wafers processed (0-500) found during the test. It can be seen that the level of particle generation is below 30, which is normal for the chamber, indicating that the confinement rings 202, small plasma volume 240, and exhaust pump 220 speed help to minimize plasma contact with the walls of the chamber so that formed ammonium fluoride does not have a chance to condense onto the walls of the chamber to form a higher number of particles.

In another embodiment of the invention, where the trench level low k material layer 424 and the via level low k material 416 are made of an OSG material the trench level low k material 424, the via level low k material 416, the ARC layer 428, barrier layer 412, and the trench stop layer 420 may be all etched with fluorine containing etchant gases. For stripping the patterned resist layer 432 an NH₃ stripping gas may be used. More preferably an NH₃ gas combined with a CF₄ gas may be used to strip the patterned resist layer. In such an embodiment an ammonia containing gas and a fluorine containing gas are used at the same time within the same plasma chamber and at alternating times.

In other embodiments other types of plasma confinement devices, which keep plasma from the chamber walls may be used in place of the confinement rings. Other types of plasma generation and energizing systems may be used in place of the upper and lower electrodes 204, 208 and the first and second RF sources 244, 248, which may generate and energize a plasma in a small plasma volume.

Another embodiment of the invention may use a combined resist strip and barrier etch step to reduced etching damage as described in U.S. patent application Ser. No. ______ (Attorney Docket Number LAM1P158) entitled “A Combined Resist Strip And Barrier Etch Process For Dual Damascene Structures” by Rao Annapragada and Reza Sadjadi, with the same filing date, and which is incorporated by reference.

Sidewalls formed by the crust may be removed during the stripping of the resist or may be removed using a separate wet stripping as described in U.S. patent application Ser. No. ______ (Attorney Docket Number LAM1P156) entitled “Method of Preventing Damage To Organo-Silicate-Glass Materials During Resist Stripping” by Rao Anapragada, with the same filing date, and which is incorporated by reference.

While this invention has been described in terms of several preferred embodiments, there are alterations, permutations, and substitute equivalents, which fall within the scope of this invention. It should also be noted that there are many alternative ways of implementing the methods and apparatuses of the present invention. It is therefore intended that the following appended claims be interpreted as including all such alterations, permutations, and substitute equivalents as fall within the true spirit and scope of the present invention.

What is claimed is:

1. An apparatus for etching stacks on a substrate, comprising:
a plasma chamber with chamber walls;
a plasma confinement device for reducing plasma contact with the chamber walls;
a gas source, comprising:
a fluorine containing gas source;
an ammonia containing gas source;
plasma generation and energizing device; and
an exhaust system for pumping plasma away.

2. The apparatus, as recited in claim 1, further comprising a chuck for supporting the substrate within the plasma chamber, wherein the plasma confinement device confines the plasma adjacent to the substrate.

3. The apparatus, as recited in claim 2, wherein the stack comprises a layer with a low dielectric constant material and an etch stop layer.

4. The apparatus, as recited in claim 3, wherein the plasma generation and energizing device comprises an upper electrode and a lower electrode spaced apart from the upper electrode.

5. The apparatus, as recited in claim 4, wherein the plasma confining device comprises a plurality of spaced apart plasma rings.

6. The apparatus, as recited in claim 5, wherein the upper electrode and lower electrode are spaced apart by a distance less than 2.0 cm.

7. The apparatus, as recited in claim 6, wherein the exhaust system is able to maintain a pressure below 300 mTorr within the chamber walls.

8. The apparatus, as recited in claim 1, wherein the plasma generation and energizing device comprises an upper electrode and a lower electrode spaced apart from the upper electrode.

9. The apparatus, as recited in claim 8, wherein the plasma confining device comprises a plurality of spaced apart plasma rings.

10. The apparatus, as recited in claim 9, wherein the upper electrode and lower electrode are spaced apart by a distance less than 2.0 cm.

11. The apparatus, as recited in claim 10, wherein the exhaust system is able to maintain a pressure below 300 mTorr within the chamber walls.

12. The apparatus, as recited in claim 8, wherein the upper electrode and lower electrode are spaced apart by of distance less than 2.0 cm.

14. The apparatus, as recited in claim 1, wherein the plasma confining device comprises a plurality of spaced apart plasma rings.

15. The apparatus, as recited in claim 14, wherein the exhaust system is able to maintain a pressure below 300 mTorr within the chamber walls.

16. A method of etching a stack, comprising:
placing the stack in a plasma processing chamber;
flowing a fluorine containing gas into the plasma processing chamber;
flowing an ammonia containing gas into the plasma processing chamber;
generating a plasma; and
etching the stack.

17. The method, as recited in claim 11, further comprising confining the plasma to reduce plasma contact with chamber walls.

18. The method, as recited in claim 12, wherein the stack comprises a low dielectric constant layer and an etch stop layer over a substrate.

19. The method, as recited in claim 17, wherein the fluorine containing gas and the ammonia containing gas are provided in an alternating manner and wherein a plasma is generated from the fluorine containing gas and a plasma is generated from the ammonia containing gas.
